(19) United States
(12) Patent Application Publication
(10) Pub. No.: US 2009/0247192 A1
(43) Pub. Date: Oct. 1, 2009

(54) SYSTEM FOR MOBILE ADVANCED MATCHING

(75) Inventors: Arvind Gupta, San Carlos, CA (US); Ashutosh Tiwari, Studio City, CA (US); Gopalakrishnan Venkatraman, Campbell, CA (US); Dominic Cheung, South Pasadena, CA (US); Stacy R. Bennett, Pasadena, CA (US); Douglas B. Koen, Austin, TX (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/059,386

(22) Filed: Mar. 31, 2008

(51) Int. Cl. H04Q 7/20

(52) U.S. Cl. 455/456.3

(57) ABSTRACT

A system is described for mobile advanced matching. The system may include a processor, a memory and an interface being operatively connected. The memory may store advertisements and a request. The interface may communicate with a user on a mobile device associated with a mobile carrier. The processor may associate the advertisements with one or more content types. The content types may describe the content of the advertisements. The processor may receive a request for items of a content type from the user via the interface. The processor may identify the content type of the items. The processor may determine an advertisement associated with the content type of the items. The processor may provide the advertisement to the user via the interface.

### TECHNICAL FIELD

The present description relates generally to a system and method, generally referred to as a system, for mobile advanced matching, and more particularly, but not exclusively, to matching mobile advertisements to search concepts and the content type of user requested content.

### BACKGROUND

Mobile advertising may play an important role in generating revenue in the mobile world. The mobile advertising market may grow as users become more comfortable with using their mobile phones as web access devices. The mobile phone may present advertisers with access to consumers everywhere the consumers take their mobile phones. However, the traditional model of targeting advertisements to queries may be ineffective when targeting a user on a mobile device. Users may interact with a mobile device differently than they might interact with a computer. Semantics and user intent may differ on a mobile device and on a computer. There may be constraints relative to using the mobile device that may effect how a user interacts with the mobile device, such as a mobile device may have a limited amount of screen space. The limited amount of screen space may reduce the number of mobile advertisements that may be served to a user over a mobile phone and may emphasize the importance of providing relevant mobile advertisements to users.

### SUMMARY

A system is disclosed for mobile advanced matching. The system may include a processor, a memory and an interface. The memory may store a plurality of advertisements and a request. The interface may communicate with a user on a mobile device associated with a mobile carrier. The processor may associate each advertisement with one or more content types. The content types may describe the content of the advertisements. The processor may receive a request for items of a content type from the user via the interface. The processor may identify the content type of the items and may determine an advertisement associated with the content type. The processor may provide the advertisement to the user via the interface.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for mobile advanced matching.

FIG. 2 is a block diagram of a simplified view of a network environment implementing the system of FIG. 1 or other systems for mobile advanced matching.

FIG. 3 is a block diagram of a view of the server side components in the system of FIG. 1 or other systems for mobile advanced matching.

FIG. 4 is a flowchart illustrating operations of advanced matching through search concepts in the system of FIG. 1, or other systems for mobile advanced matching.

FIG. 5 is a flowchart illustrating operations of advanced matching through the content type of user requested content in the system of FIG. 1, or other systems for mobile advanced matching.

FIG. 6 is a flowchart illustrating operations of a user interacting with a content cluster in the system of FIG. 1, or other systems for mobile advanced matching.

FIG. 7 is an illustration of a mobile device displaying a mobile advertisement matched to a search query using advanced matching through search concepts in the system of FIG. 1 or other systems for mobile advanced matching.

FIG. 8 is an illustration of a mobile device displaying a mobile advertisement matched to the content type of user requested search results using advanced matching in the system of FIG. 1 or other systems for mobile advanced matching.

FIG. 9 is an illustration a general computer system that may be used in a system for mobile advanced matching.

### DETAILED DESCRIPTION

The present description relates generally to a system and method, generally referred to as a system, for mobile advanced matching, and more particularly, but not exclusively, to matching mobile advertisements to search concepts and the content type of user requested content.

The system may provide for advanced matching in mobile advertising. The advanced matching may increase the effectiveness of mobile advertising by increasing the exposure of mobile advertisements to users. The system may match mobile advertisements to search queries based on the intent, or underlying concept, of the search queries. The system may associate search queries and mobile advertisements with search concepts related to the intent of the search queries. The search concept associated with a search query and/or a mobile advertisement may be determined by algorithmic inference or manual categorization. The system may receive a search query from a user and may determine the search concept associated with the search query. The system may retrieve a mobile advertisement associated with the search concept and may provide the mobile advertisement to the user. The system may allow for unique sets of search concepts for each mobile carrier.

The system may continually update the search queries and mobile advertisement associated with a search concept. If new relevant search queries and mobile advertisements become available they may be associated with the search concept, and if existing search queries and mobile advertisements become irrelevant they may be removed from the search concept. Thus, the system continually associates mobile advertisements with relevant search queries and eliminates the need for an advertiser to repeatedly update the keywords associated with a mobile advertisement.

The system may provide for matching advertisements based on a semantic intent of a user's search query. The system may identify the semantic intent of a search query and may associate the search query with a search concept representing the semantic intent. The system may also associate the advertisements with a search concept related to the content of the advertisements. The system may receive search queries from users and may serve advertisements associated with the search concept of the search queries, regardless of whether the advertisements are targeted to the search queries themselves.

The system may provide for matching advertisements with the type of content requested by the users. The system may associate the advertisements with a content type by algorithmic inference, or manual categorization. Alternatively or in addition an advertiser may specify the content type to associate with their advertisement. The system may receive a request from a user for additional content of a particular content type and may provide the additional content and an advertisement associated with the content type of the additional content.

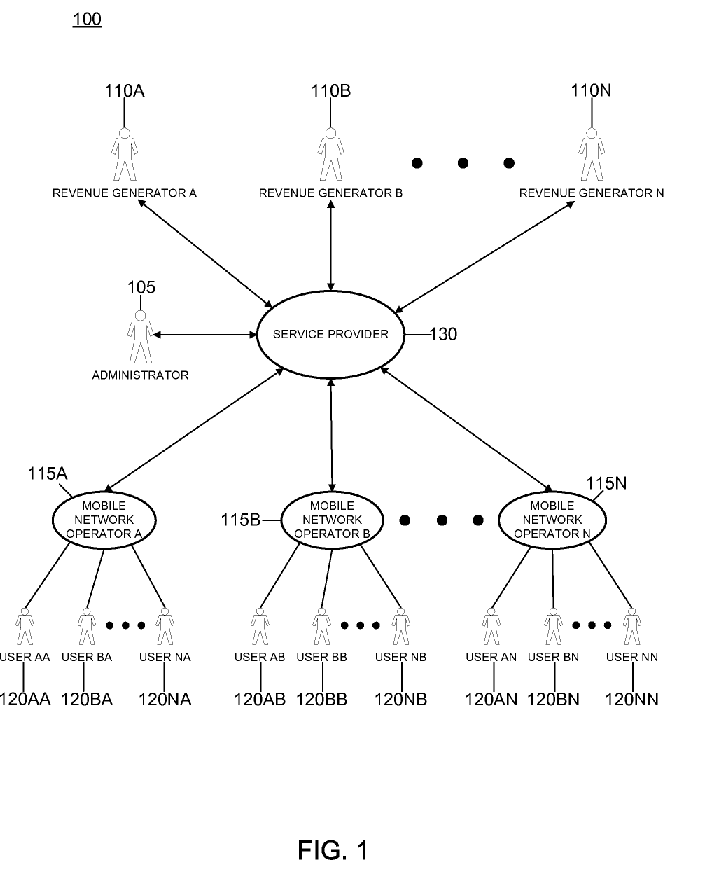

FIG. 1 provides a general overview of a system 100 for mobile advanced matching. Not all of the depicted components may be required, however, and some implementations may include additional components. Variations in the arrangement and type of the components may be made without departing from the spirit or scope of the claims as set forth herein. Additional, different or fewer components may be provided.

The system 100 may include an administrator 105, one or more revenue generators 110A-N, such as mobile advertisers, a service provider 130, such as a portal or an advertising service provider, one or more mobile network operators (“MNOs”) 115A-N, more commonly referred to as mobile carriers, or simply carriers, and one or more users 120AA-NN, such as mobile subscribers or consumers. The service provider 130 may implement an advertising campaign management system incorporating an auction based and/or non-auction based advertisement serving system.

The advertising campaign management system may support targeting advertisements to the users 120AA-NN through a variety of advertising tactics, such as search targeting, content match targeting and behavioral profile targeting. Search targeting may refer to targeting advertisements to search queries provided by the users, content match targeting may refer to targeting advertisements to the content of a particular page or pages, and behavioral profile targeting may refer to targeting advertisements to the behavior of the users 120AA-NN.

The revenue generators 110A-N may pay the service provider 130 to serve, or display, advertisements of their goods or services, such as on-line or mobile advertisements, to the users 120AA-NN, such as over mobile messaging, mobile web, the Internet, or generally any venue for displaying advertisements. The advertisements may include sponsored listings, banners ads, popup advertisements, mobile messages, or generally any way of attracting the users 120AA-NN to the web site or mobile site of the revenue generators 110A-N. The revenue generators 110A-N may bid on specific MNOs 115A-N to target their advertisements to. For example, the revenue generator A 110A may bid on one or more keywords searched for via the MNO A 115A. In this case the mobile advertisements of the revenue generator A 110A may only be displayed to the users 120AA-NA when the users 120AA-NA search for the keywords bid on through the MNO A 115A.

The users 120AA-NN may be consumers of goods or services who may be searching for a business, such as the business of one of the revenue generators 110A-N. The users 120AA-NN may be searching for the mobile presence of one of the revenue generators 110A-N, or the real world, or brick and mortar, presence of one of the revenue generators 110A-N. Alternatively or in addition the users 120AA-NN may be machines or other servers, such as a third party server. The users 120AA-NN may need a user identifier or identification (“user ID”) to access the services of the service provider 130. In order to obtain a user ID the users 120AA-NN may need to supply information describing themselves to the service provider 130, such as gender, and/or age of the users 120AA-NN, or generally any information that may be required for the users 120AA-NN to utilize the services provided by the service provider 130. The service provider 130 may collect user behavior data from the users 120AA-NN when they are logged in, such as queries searched for by the users 120AA-NN, links clicked on by the users 120AA-NN and/or any user interactions with the services provided by the service provider 130.

The MNOs 115A-N may provide a mobile network to the users 120AA-NN which may provide a variety of services to the users 120AA-NN, such as the ability to send and receive phone calls, send and receive mobile messages, to access the internet and/or the mobile web, or generally any service that may be implemented on a mobile device. The MNOs 115A-N may store data describing the users 120AA-NN, such as billing addresses, call histories, messaging histories, or generally any data regarding the users 120AA-NN that may be available to the MNOs 115A-N.

The service provider 130 may maintain a mobile portal and/or a web portal, such as a search site, where the service provider 130 may display advertisements of the revenue generators 110A-N to the users 120AA-NN. The users 120AA-NN may use mobile devices to interact with the search site provided by the service provider 130 to search for information on the mobile web. One of the users 120AA-NN, such as the user AA 120AA, may communicate a search query to the service provider 130 relating to the information they are searching for. The service provider 130 may provide data related to the query and mobile advertisements related to the query to the users 120AA-NN. Alternatively or in addition the service provider 130 may provide advertisements to a third party server, such as a third party search portal. The third party server may submit an advertisement request to the service provider 130 through an interface such as an application programming interface (“API”). The service provider 130 may use the data submitted with the request to retrieve and return relevant advertisements to the third party server.

Alternatively or in addition the service provider 130 may be an advertising services provider. Third party entities, such as the MNOs 115A-N may request advertisements from the service provider 130 through an API. The service provider 130 may return mobile advertisements of the revenue generators 110A-N to the MNOs 115A-N. The MNOs 115A-N may then display the advertisements to the users 120AA-NN. The service provider 130 may share revenue with the mobile network operators MNOs 115A-N of the users 120AA-NN for displaying advertisements of the revenue generators 110A-N via their mobile networks. Alternatively or in addition the service provider 130 may share revenue with individual publishers for displaying advertisements of the revenue generators 110A-N on their mobile and/or web sites. The service provider 130 may supply the API to the MNOs 115A-N enabling the MNOs 115A-N to request advertisements from the service provider 130.

The service provider 130 may create one or more search concepts related to themes or topics commonly searched for the by the users 120AA-NN. The service provider 130 may maintain a separate set of search concepts for each of the MNOs 115A-N. Maintaining separate search concepts for each of the MNOs 115A-N may ensure that the search concepts properly represent the search intent of the users 120AA-NN on each of the MNOS 115A-N. Alternatively or in addition the service provider 130 may maintain one set of search concepts across all of the MNOs 115A-N. Alternatively or in addition the service provider 130 may maintain a separate set of search concepts for each of the users 120AA-NN.

The service provider 130 may associate the mobile advertisements of the revenue generators 110A-N on each of the MNOs 115A-Ns with one or more of the search concepts. The service provider 130 may also associate one or more related search queries to the search concept for each of the MNOs 115A-N. The service provider 130 may use an algorithmic inference, such as through matching algorithms, to infer which mobile advertisements and search queries may relate to a given search concept. Alternatively or in addition the administrator 105 may interact with the system 100 to create the search concepts and associate the mobile advertisements and the search queries with the search concepts for each of the MNOs 115A-N. Alternatively or in addition the revenue generators 110A-N may associate their mobile advertisements with one or more search concepts.

The service provider 130 may dynamically maintain the search concepts based on the popularity of related mobile search queries. For example, during the weeks leading up to an event, such as the “Super Bowl,” the number of searches related to the “Super Bowl” may increase significantly. The service provider 130 may group the search queries related to the“Super Bowl” into a “Super Bowl” search concept. The service provider 130 may associate the mobile advertisements that relate to the “Super Bowl” with the “Super Bowl” search concept. When a user AA 120AA searches for one of the search queries associated with the “Super Bowl” search concept the service provider 130 may provide one or more of the mobile advertisements associated with the “Super Bowl” search concept.

The service provider 130 may only display the mobile advertisements associated with the search concept if there are no mobile advertisements targeted directly to the search query for the mobile carrier A 115A. Alternatively or in addition the service provider 130 may provide a combination of mobile advertisements associated with the search concept and mobile advertisements targeted to the search query. Alternatively or in addition the service provider 130 may process the mobile advertisements associated with the search concept and the mobile advertisements targeted to the search query to determine which advertisements may be the most relevant, profitable, or otherwise more advantageous to display to the user AA 120AA.

The service provider 130 may also associate each of the mobile advertisements of the revenue generators 110A-N with one or more content types. The content type association may be used to display mobile advertisements to the users 120AA-NN when the users 120AA-NN view several search results of a particular content type. For example, the service provider 130 may provide the user AA 1 20AA with several search results of different content types. The content types may be locations, events, people, or generally any segmentation of search results related to the content of the search results. Each of the search results displayed to the user AA 120AA may be accompanied by a link to view additional search results of the same content type. If the user AA 120AA requests additional search results of the same content type, the user AA 120AA may be provided with a cluster of results of the same content type, and one or more mobile advertisements associated with the content type. The cluster of search results of the same content type may be referred to as a content cluster.

The service provider 130 may create one or more content types and may use an algorithmic inference, such as through a matching algorithm, to associate each of the mobile advertisements and each of the search results to the one or more content types. The service provider 130 may maintain one set of content type associations for all of the MNOs 115A-N. Alternatively or in addition the service provider 130 may maintain separate sets of content types for each of the MNOs 115A-N, and/or each of the users 120AA-NN. Alternatively or in addition, the administrator 105 may create the one or more content types and may associate each of the search results and each of the mobile advertisements with the one or more content types. Alternatively or in addition the revenue generators 110A-N may target their mobile advertisements to the content types.

In the system 100, the revenue generators 110A-N may interact with the service provider 130, such as via a web application. The revenue generators 110A-N may send information, such as billing, website or mobile site, queries, and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application. Alternatively or in addition the revenue generators 110A-N may interact with the service provider 130 via a mobile device.

The users 120AA-NN may also interact individually with the service provider 130, through the mobile network operators 115A-N, such as via a mobile phone or any mobile device capable of communicating with the mobile network operators 115A-N. The users 120AA-NN may interact with the service provider 130 via a mobile web based application, a mobile standalone application, or any application capable of running on a mobile device. The service provider 130 may communicate data to the revenue generators 110A-N over a network and to the users 120AA-NN over a network via the MNOs 115A-N. The following examples may refer to a revenue generator A 110A as an online advertiser or mobile advertiser; however the system 100 may apply to any revenue generators 110A-N who may desire to serve advertisements to users 120AA-NN over mobile devices.

Furthermore, the service provider 130 may generate reports based on the data collected from the users 120AA-NN and communicate the reports to the revenue generators 110A-N to assist the revenue generators 110A-N in measuring the effectiveness of their mobile advertising campaigns. The reports may indicate the number of times the users 120AA-NN viewed a mobile advertisement of the revenue generators 110A-N, the number of times a mobile advertisement of the revenue generators 110A-N was clicked on by the users 120AA-NN, or generally any information useful to the revenue generators 110A-N. The reports may include the number of times a mobile advertisement of the revenue generator A 110A was displayed to a user AA 120AA as a result of a search concept association and the number of times a mobile advertisement was displayed to a user AA 120AA as a result of a content type association.

More detail regarding the aspects of a mobile advertising auction-based systems, as well as the structure, function and operation of the service provider 130 as a mobile advertising provider, as mentioned above, can be found in commonly owned U.S. patent application Ser. No. 11/712,276, filed on Feb. 28, 2007, entitled, “SYSTEM FOR SERVING ADVERTISEMENTS OVER MOBILE DEVICES,” which is hereby incorporated herein by reference in its entirety. The systems and methods herein associated with mobile advertising campaign management may be practiced in combination with methods and systems described in the above-identified patent application incorporated by reference.

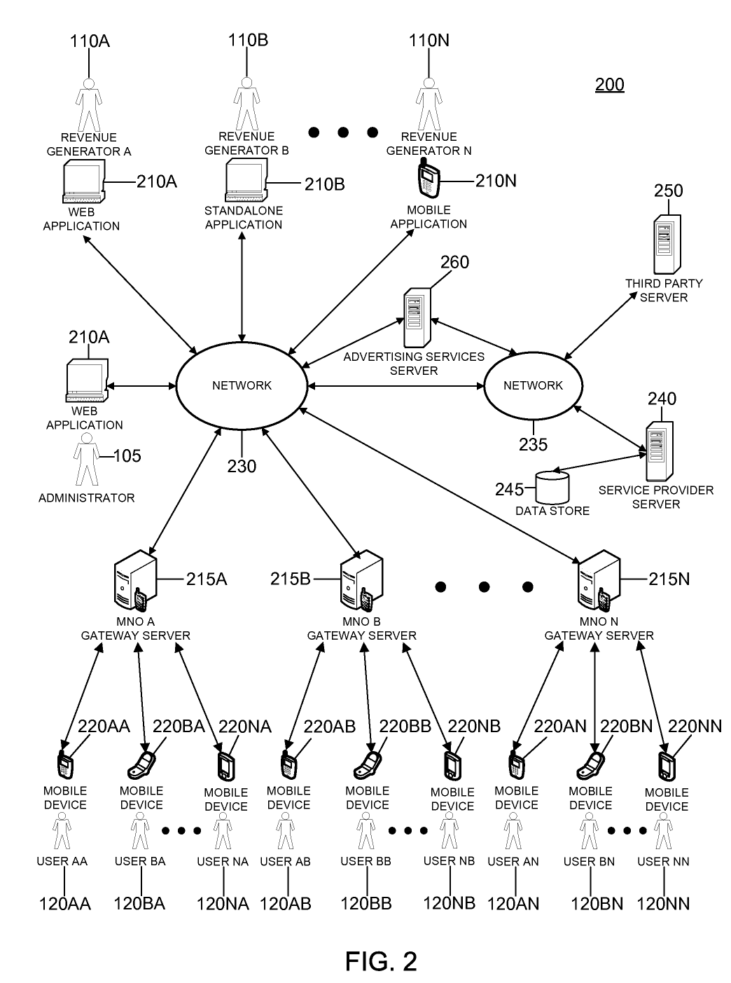

FIG. 2 provides a simplified view of a network environment implementing a system 200 for mobile advanced matching. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more web applications, standalone applications and mobile applications 210A-N, which may be collectively or individually referred to as client applications of the revenue generators 110A-N. The system 200 may also include one or more mobile applications, or mobile apps, which may be running on one or more mobile devices 220AA-NN. The system 200 may also include an administrator 105, one or more MNO gateway servers 215A-N, a network 230, a network 235, a data store 245, the service provider server 240, a third party server 250, and an advertising services server 260.

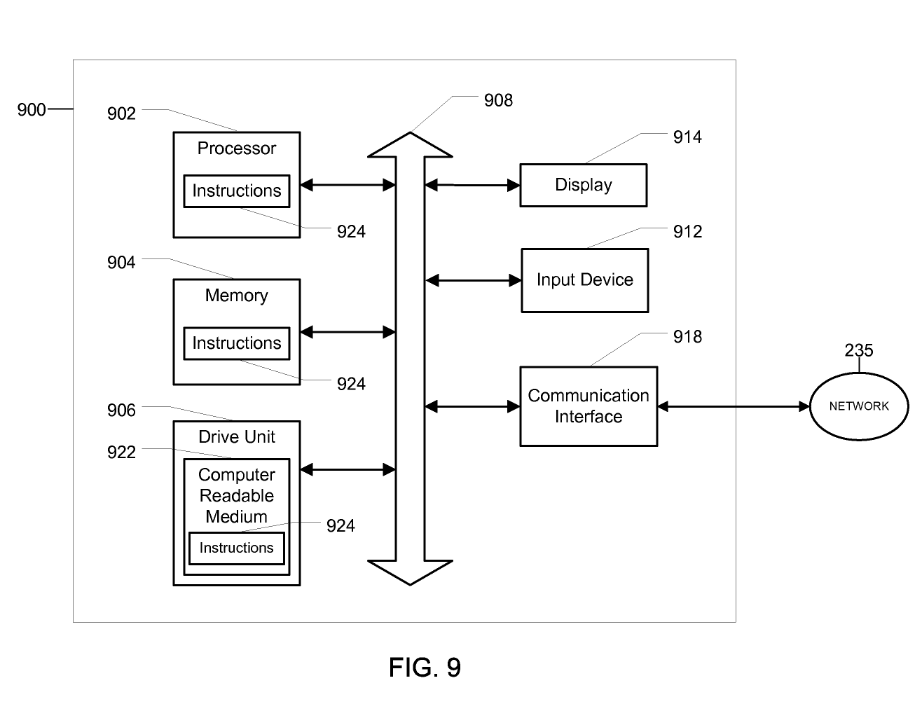

Some or all of the advertisement services server 260, service provider server 240, and third-party server 250 may be in communication with each other by way of network 235 and may be implemented with the system or components described below in FIG. 9. The advertisement services server 260, third-party server 250 and service provider server 240 may each represent multiple linked computing devices. Multiple distinct third party servers, such as the third-party server 250, may be included in the system 200. The third-party server 250 may be an MNO gateway server 215A-N or a server associated with, or in communication with an MNO gateway server 215A-N.

The data store 245 may be operative to store data, such as data relating to interactions with the users 120AA-NN. The data store 245 may store data describing the search concepts, the content types, and the associations between the search concepts and concept types and the search results, search queries, and mobile advertisements. The system 100 may maintain and update data related to the associations between the search concepts and concept types and the search results, search queries and mobile advertisements of the revenue generators 110A-N. There may be a server or a set of servers dedicated to tracking and updating the associations. The data store 245 may include one or more relational databases or other data stores that may be managed using various known database management techniques, such as, for example, SQL and object-based techniques. Alternatively or in addition the data store 245 may be implemented using one or more of the magnetic, optical, solid state or tape drives. The data store 245 may be in communication with the service provider server 240. Alternatively or in addition the data store 245 may be in communication with the service provider server 240 through the network 235.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. The service provider server 240 may communicate to the revenue generators 110A-N via the networks 230, 235, through the web applications, standalone applications or mobile applications 210A-N. The administrator 105 may use a web application 210A to interact with the service provider server 240 over the networks 230, 235.

The users 120AA-NN may use a mobile application running on a mobile device 220AA-220NN, such as a mobile web browser, to communicate with the service provider server 240, via the MNO gateway servers 215A-N and the networks 230, 235. The service provider server 240 may communicate to the users 120AA-NN via the networks 230, 235 and the MNO gateway servers 215A-N, through the mobile devices 220AA-NN.

The web applications, standalone applications, mobile applications and mobile devices 210A-N, 220AA-NN may be connected to the network 230 in any configuration that supports data transfer. This may include a data connection to the network 230 that may be wired or wireless. Any of the web applications, standalone applications and mobile applications 210A-N, may individually be referred to as a client application. The web application 210A may run on any platform that supports web content, such as a web browser or a computer, a mobile phone, personal digital assistant (PDA), pager, network-enabled television, digital video recorder, such as TIVO, automobile and/or any appliance capable of data communications.

The standalone applications 210B may run on a machine that may have a processor, memory, a display, a user interface and a communication interface. The processor may be operatively connected to the memory, display and the interfaces and may perform tasks at the request of the standalone applications 210B or the underlying operating system. The memory may be capable of storing data. The display may be operatively connected to the memory and the processor and may be capable of displaying information to the revenue generator B 110B. The user interface may be operatively connected to the memory, the processor, and the display and may be capable of interacting with the revenue generator B 110B. The communication interface may be operatively connected to the memory, and the processor, and may be capable of communicating through the networks 230, 235 with the service provider server 240, third party server 250 and advertising services server 260. The standalone applications 210B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile application 210N may run on any mobile device which may have a data connection. The mobile applications 210N may be a web application 210A, a standalone application 210B, or a mobile browser. The mobile devices 220AA-NN may be one of a broad range of electronic devices which may include mobile phones, PDAs, and laptops and notebook computers. The mobile devices 220AA-NN may have a reduced feature set, such as a smaller keyboard and/or screen, and may be incapable of supporting a traditional web search and/or display.

The data connection of the mobile devices 220AA-NN may be a cellular connection, such as a GSM/GPRS/WCDMA connection, a wireless data connection, an internet connection, an infra-red connection, a Bluetooth connection, or any other connection capable of transmitting data. The data connection may be used to connect directly to the network 230, or to connect to the network 230 through the MNO gateway servers 215A-N.

The MNO gateway servers 215A-N may control the access the mobile devices 220AA-NN may have to the networks 230, 235. The MNO gateway servers 215A-N may also control the technology supporting the respective mobile devices 220AA-NN. This may affect aspects of the user experience, such as signal strength and availability, speed and billing mechanisms. For example, the MNO A gateway server 215A may only allow the users 120AA-NA access to content provided by partners of the MNO A 115A. Furthermore, the MNO gateway servers 215A-N may only allow users 120AA-NN access to data in a specific format, such as WML, XHTML, NTT DOCOMO IMODE HTML, or cHTML. Alternatively or in addition, the mobile devices 220AA-NN may only support one of the aforementioned formats.

The MNOs 115A-N may utilize various components to provide these services to the users 120AA-NN, such as network switching systems (“NSS”), mobile switching centers (“MSC”), mobile switching center servers (“MSC-S”), home location registers (“HLR”), authentication centers (“AUC”), short message service centers (“SMSC”), signal transfer points (“STP”), message service centers (“MSC”), or generally any component that may be utilized to provide the mobile services. The MNOs 115A-N may interface with one or more external short messaging entities (ESME), such as the third party server 250, which may connect to the MNOs 115A-N to send and/or receive mobile messages to the users 120AA-NN. The ESMEs may provide voicemail, web, email, or other services to the users 120AA-NN of the MNOs 115A-N.

The service provider server 240 may include one or more of the following: an application server, a data source, such as a database server, a middleware server, and an advertising services server. One middleware server may be a mobile commerce platform, such as the YAHOO! SUSHI platform, which may properly encode data, such as mobile pages or mobile advertisements, to the formats specific to the MNO gateway servers 215A-N. The service provider server 240 may co-exist on one machine or may be running in a distributed configuration on one or more machines. The service provider server 240 may receive requests from the users 120AA-NN and the revenue generators 110A-N and may serve web pages and/or mobile pages to the users 120AA-NN and web pages and/or mobile pages to the revenue generators 110A-N based on their requests.

The third party server 250 may include one or more of the following: an application server, a data source, such as a database server, a middleware server, and an advertising services server. The third party server 250 may co-exist on one machine or may be running in a distributed configuration on one or more machines. Alternatively or in addition, the third party server may be a third party matching algorithm provider server. The advertising services server 260 may provide a platform for the inclusion of advertisements in pages, such as web pages or mobile pages. The advertisement services server 260 may be used for providing mobile advertisements that may be displayed to the users 120AA-NN. The third party server 250 may request advertisements from the service provider server 240 or the advertisement services server 260 via an API.

The service provider server 240, the third party server 250 and the advertising services server 260 may be one or more computing devices of various kinds, such as the computing device 900 in FIG. 9. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120AA-NN and the revenue generators 110A-N. The advertising services server 260 may provide a platform for the inclusion of advertisements in pages, such as web pages. The advertising services server 260 may also exist independent of the service provider server 240 and the third party server 250.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

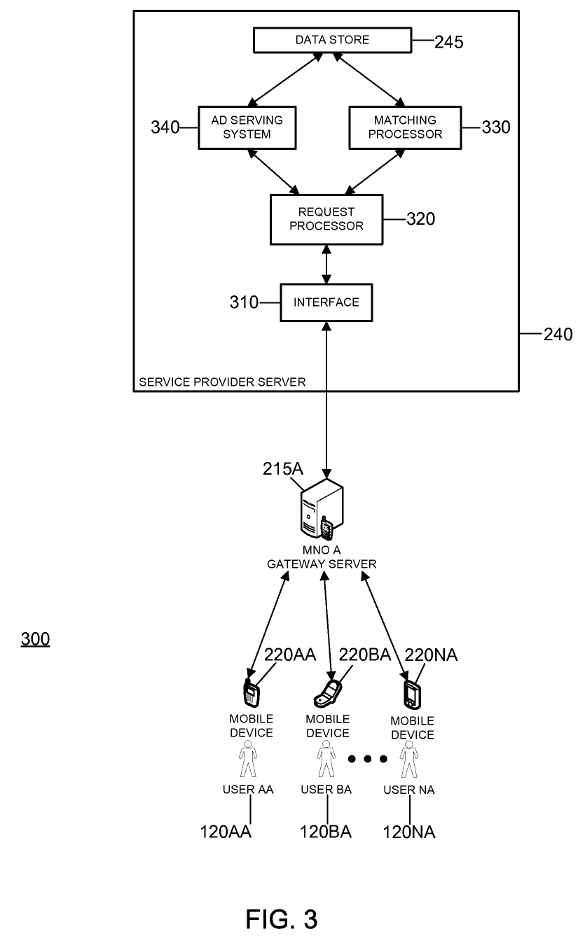

FIG. 3 is a block diagram of a view of the server side components in the system of FIG. 1 or other systems for mobile advanced matching. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 300 may include the service provider server 240, the MNO A gateway server 215A, the mobile devices 220AA-NA, and the users 120AA-NA. The service provider server 240 may include an interface 310, a request processor 320, a matching processor 330, an ad serving system 340, and a data store 245. The interface 310 may enable the MNO A gateway server 215A to communicate with the service provider server 240. The request processor 320 may process a request from the mobile devices 220AA-NA and/or the MNO A gateway server 215A to identify the query searched for and to identify the originating MNO A gateway server 215A and/or the mobile devices 220AA-NA.

The matching processor 330 may analyze each request to determine whether the search query associated with the request should be associated with a search concept. The matching processor 330 may analyze the mobile advertisements in the data store 245 and determine whether the mobile advertisements should be associated with one or more search concepts or one or more content types. If the service provider server 240 maintains search results in the data store 245, the matching processor 330 may analyze the search results to determine if the search results should be associated with a content type. Alternatively or in addition the matching processor 330 may provide an interface to the administrator 105. The interface may allow the administrator 105 to interact with the data store 245 and maintain the associations between the search concepts and the content types and the search queries, search results and mobile advertisements.

The ad serving system 340 may receive a request from the request processor 320 and may retrieve one or more mobile advertisements related to the request. If the request is a search query, the ad serving system 340 may retrieve one or more mobile advertisements targeted to the search query on the MNO A 115A. The ad serving system 340 may also retrieve the search concept of the search query from the data store 245 and may retrieve one or more mobile advertisements associated with the search concept. If the search query is not associated with a search concept, the ad serving system 340 may communicate the search query to the matching processor 330. The matching processor may associate the search query with a search concept and may store the association in the data store 245. If the request is for a cluster of search results of the same content type, the ad serving system 340 may determine the content type of the search results, may retrieve one or more mobile advertisements associated with the content type from the data store 245, and may provide the one or more mobile advertisements to the user AA 120AA.

In operation one of the users 120AA-NA, such as the user AA 120AA, may perform a query search via the mobile device 220AA. The mobile device 220AA may communicate the query to the service provider server 240 via the MNO A gateway server 215A. The interface 310 may receive the request and communicate the request to the request processor 320. The request processor 320 may process the request from the MNO A gateway server 215A and may communicate the request to the ad serving system 340 and/or the matching processor 330.

The matching processor 330 may determine whether the search query is associated with a search concept. If the search query is not associated with a search concept, the matching processor 330 may determine whether the search query can be matched to an existing search concept. The matching processor 330 may utilize a matching algorithm, such as one supplied by the third party server 250, to determine a search concept to associate with the search query. If the search query can not be associated with an existing search concept, the matching processor 330 may determine whether a new search concept should be created for the search query. The matching processor 330 may use search metrics, such as the number of times the search query has been searched for by the users 120AA-NN, and the number of times similar queries have been searched for by the users 120AA-NN, to determine whether a new search concept should be created. The matching processor 330 may retrieve and store the search metrics in the data store 245.

The ad serving system 340 may retrieve any search concepts matched to the search query, for the MNO A 115A, from the data store 245 and may communicate the search concepts to the ad serving system 340. The ad serving system 340 may retrieve one or more mobile advertisements targeted to the search query and the MNO A 115A, and/or may retrieve one or more mobile advertisements associated with the search concept associated with the search query and the MNO A 115A. The ad serving system 340 may provide the mobile advertisements to the user AA 120AA via the MNO gateway server A 215A.

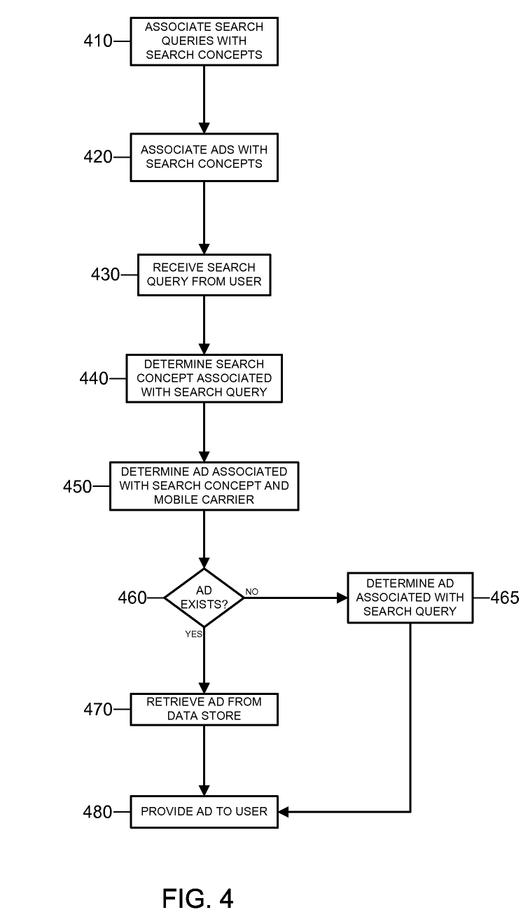

FIG. 4 is a flowchart illustrating operations of advanced matching through search concepts in the system of FIG. 1, or other systems for mobile advanced matching. At block 410 the service provider 130 may associate one or more search queries with one or more search concepts. The service provider 130 may store the associations in the data store 245. The service provider 130 may use a clustering algorithm to cluster the search queries into one or more search concepts. The search concepts may be identified by one or more terms occurring most frequently in each of the search queries. Alternatively or in addition the administrator 105 may determine the one or more search concepts and may associate the one or more search concepts with the one or more search queries. Alternatively or in addition, the service provider 130 may use the search results generated by a search query to determine the search concept to associate with the search query.

At block 420 the service provider 130 may associate one or more mobile advertisements to the one or more search concepts. The service provider 130 may use a matching algorithm to match the characteristics of the mobile advertisements to the characteristics of the search concepts. For example, the service provider 130 may match one or more terms used to identify the search concept with one or more terms existing in the mobile advertisement. Alternatively or in addition the service provider 130 may use a matching system provided by a third party, such as through the third party server 250, to match the mobile advertisements to the search concepts.

At block 430 the service provider 130 may receive a search query from the user AA 120AA via the MNO A 115A. At block 440 the service provider 130 may determine the search concept associated with the search query for the MNO A 115A. If no search concept is associated with the search query, the service provider 130 may determine whether the search query can be associated with an existing search concept. At block 450 the service provider 130 may determine whether there exists one or more mobile advertisements associated with the search concept for the MNO A 115A. If at block 460 there are no mobile advertisements associated with the search concept for the MNO A 115A, the system 100 may move to block 465. At block 465 the system 100 may retrieve one or more mobile advertisements targeted to the search query and the MNO A 115A. The system may then move to block 480.

If at block 460 there exists one or more mobile advertisements associated with the search concept for the MNO A 115A, the system 100 may move to block 470. At block 470 the service provider 130 may retrieve the one or more mobile advertisements from the data store 245. At block 480 the service provider 130 may provide the retrieved mobile advertisements to the user AA 120AA.

Alternatively or in addition the service provider 130 may retrieve both mobile advertisements associated with the search concept and mobile advertisements targeted to the search query for the MNO A 115A. Alternatively or in addition the service provider 130 may only retrieve mobile advertisements associated with the search concept for the MNO A 115A if the service provider 130 is unable to retrieve any mobile advertisements targeted to the search query and the MNO A 115A.

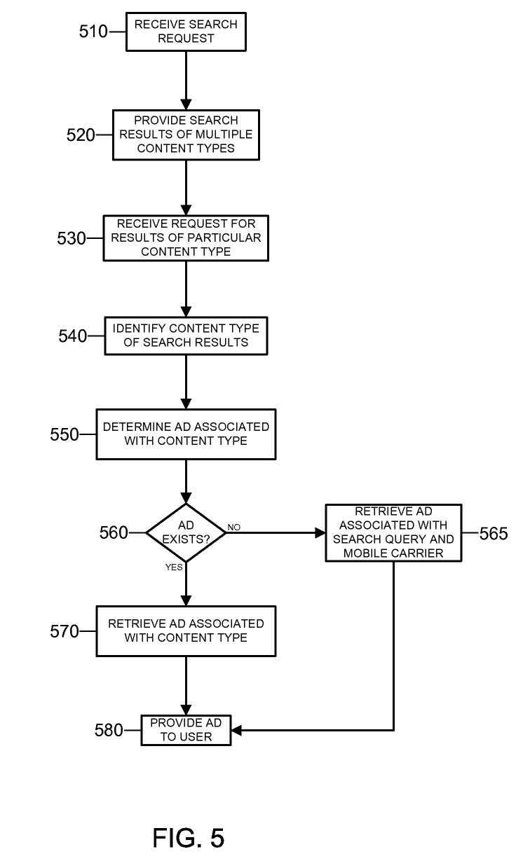

FIG. 5 is a flowchart illustrating operations of advanced matching through the content type of user requested content in the system of FIG. 1, or other systems for mobile advanced matching. At block 510 the service provider 130 may receive a search request from one of the users 120AA-NN, such as the user AA 120AA, via one of the MNOs 115A-N, such as the MNO A 115A. At block 520 the service provider 130 may provide search results to the user AA 120AA. The search results may be of varying content types and each search result may be accompanied by a link allowing the user AA 120AA to request additional search results of the same content type. At block 530 the service provider 130 may receive a request from the user AA 120AA for additional search results of a particular content type. The user AA 120AA may request one or more search results, or items, of a content type from the service provider 130 via the mobile device 220AA associated with the MNO A 115A. At block 540 the service provider 130 may identify the content type of the additional search results requested by the user AA 120AA. At block 550 the service provider 130 may determine whether there are any mobile advertisements in the data store 245 associated with the content type of the additional search results requested by the user AA 120AA. If at block 560 there are no mobile advertisements associated with the content type in the data store 245, the system 100 may move to block 565.

At block 565 the service provider 130 may retrieve a mobile advertisement targeted to the search query and the mobile carrier. The system 100 may then move to block 580. If at block 560 there exists one or more mobile advertisements associated with the content type, the system 100 may move to block 570. At block 570 the service provider 130 may retrieve the one or more mobile advertisements associated with the content type. At block 580 the service provider 130 may provide the retrieved mobile advertisements to the user AA 120AA.

Alternatively or in addition the service provider 130 may retrieve both mobile advertisements associated with the content type, and mobile advertisements targeted to the search request and the MNO A 115A. Alternatively or in addition the service provider 130 may only retrieve mobile advertisements associated with the content type if the service provider 130 is unable to retrieve mobile advertisements targeted to the search request and the MNO A 115A.

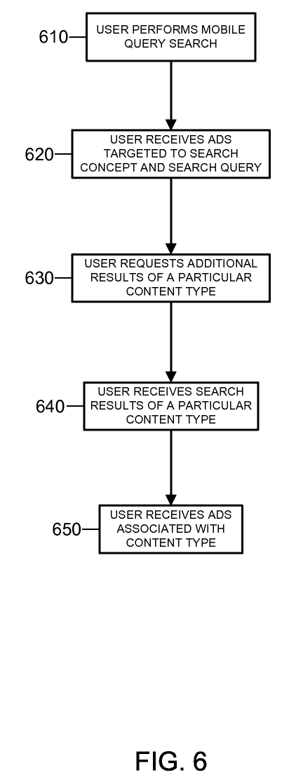

FIG. 6 is a flowchart illustrating operations of a user interacting with a content cluster in the system of FIG. 1, or other systems for mobile advanced matching. At block 610 the user AA 120AA may perform a search for a query. At block 620 the user AA 120AA may receive one or more mobile advertisements associated with the search concept of the query, and the MNO A 115A, and/or one or more mobile advertisements targeted to the search query and the MNO A 115A. At block 630 the user AA 120AA may request additional search results of a particular content type, such as by clicking on a link next to one of the search results. At block 640 the user AA 120AA may receive additional search results of the same content type, such as location results, event results, or generally any content type capable of segmenting the search results. At block 650 the user AA 120AA may receive mobile advertisements associated with the content type of the additional search results from the service provider 130. The mobile advertisements may accompany the additional search results.

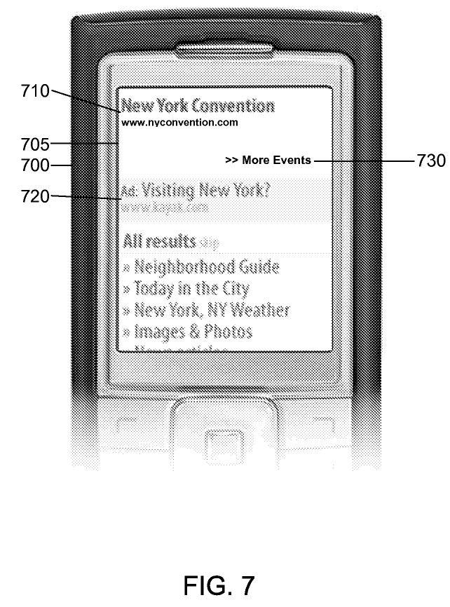

FIG. 7 is an illustration 700 of a mobile device 220AA displaying a mobile advertisement matched to a search query using advanced matching through search concepts in the system of FIG. 1 or other systems for mobile advanced matching. The illustration 700 may include a screen 705, a search result 710, a mobile advertisement 720, and link 730 for requesting additional search results of the same content type as the search result 710. The service provider may provide the screen 705 to the user AA 120AA when the user AA 120AA searches for “New York convention.” In the illustration 700, the search result 710 may be for a “New York Convention,” and the content type of the search result 710 may be “events.” The service provider 130 may provide the link 730 to allow the user AA 120AA to view additional search results with a content type of “events.” Alternatively or in addition the content type of the search results 710 may be “conventions,” “tourism,” or generally any content type related to the content of the search result 710.

The search query searched for by the user AA 120AA, “New York convention,” may be associated with the search concept of “New York.” The mobile advertisement 720 may also be associated with the search concept of “New York.” The service provider 130 may provide the mobile advertisement 720 to the user AA 120AA when the user AA 120AA searches for “New York convention,” or other search queries associated with the search concept of “New York.”

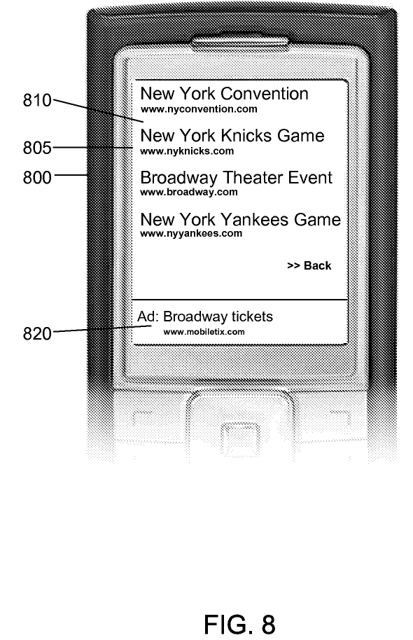

FIG. 8 is an illustration 800 of a mobile device 220AA displaying a mobile advertisement matched to the content type of user requested search results using advanced matching in the system of FIG. 1 or other systems for mobile advanced matching. The illustration 800 may include a screen 805, a content cluster 810, and a mobile advertisement 820. The service provider 130 may provide the screen 805 to a user AA 120AA when the user AA 120AA requests additional search results of the content type “events,” such as by clicking on the link 730 in FIG. 7. The content cluster 810 may be the additional search results with a content type of “events.” The mobile advertisement 820 may be associated with the content type “events,” and may be provided to the user AA 120AA with the content cluster 810.

FIG. 9 illustrates a general computer system 900, which may represent a service provider server 240, a third party server 250, an advertising services server 260, one of the mobile devices 220AA-NN or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 900 may include a set of instructions 924 that may be executed to cause the computer system 900 to perform any one or more of the methods or computer based functions disclosed herein. The computer system 900 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 900 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 924 (sequential or otherwise) that specify actions to be taken by that machine. In a particular embodiment, the computer system 900 may be implemented using electronic devices that provide voice, video or data communication. Further, while a single computer system 900 may be illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, such as, a central processing unit (CPU), a graphics processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 904 may include a cache or random access memory for the processor 902. Alternatively or in addition, the memory 904 may be separate from the processor 902, such as a cache memory of a processor, the system memory, or other memory. The memory 904 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 904 may be operable to store instructions 924 executable by the processor 902. The functions, acts or tasks illustrated in the figures or described herein may be performed by the programmed processor 902 executing the instructions 924 stored in the memory 904. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 900 may further include a display 914, such as a liquid crystal display (LCD), an organic light emitting diode (OLED), a flat panel display, a solid state display, a cathode ray tube (CRT), a projector, a printer or other now known or later developed display device for outputting determined information. The display 914 may act as an interface for the user to see the functioning of the processor 902, or specifically as an interface with the software stored in the memory 904 or in the drive unit 906.

Additionally, the computer system 900 may include an input device 912 configured to allow a user to interact with any of the components of system 900. The input device 912 may be a number pad, a keyboard, or a cursor control device, such as a mouse, or a joystick, touch screen display, remote control or any other device operative to interact with the system 900.

The computer system 900 may also include a disk or optical drive unit 906. The disk drive unit 906 may include a computer-readable medium 922 in which one or more sets of instructions 924, e.g. software, can be embedded. Further, the instructions 924 may perform one or more of the methods or logic as described herein. The instructions 924 may reside completely, or at least partially, within the memory 904 and/or within the processor 902 during execution by the computer system 900. The memory 904 and the processor 902 also may include computer-readable media as discussed above.

The present disclosure contemplates a computer-readable medium 922 that includes instructions 924 or receives and executes instructions 924 responsive to a propagated signal; so that a device connected to a network 235 may communicate voice, video, audio, images or any other data over the network 235. The instructions 924 may be implemented with hardware, software and/or firmware, or any combination thereof. Further, the instructions 924 may be transmitted or received over the network 235 via a communication interface 918. The communication interface 918 may be a part of the processor 902 or may be a separate component. The communication interface 918 may be created in software or may be a physical connection in hardware. The communication interface 918 may be configured to connect with a network 235, external media, the display 914, or any other components in system 900, or combinations thereof. The connection with the network 235 may be a physical connection, such as a wired Ethernet connection or may be established wirelessly as discussed below. Likewise, the additional connections with other components of the system 900 may be physical connections or may be established wirelessly. In the case of a service provider server 240, a third party server 250, an advertising services server 260, the servers may communicate with users 120AA-NN and the revenue generators 110A-N through the communication interface 918.

The network 235 may include wired networks, wireless networks, or combinations thereof. The wireless network may be a cellular telephone network, an 902.11, 902.16, 902.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 922 may be a single medium, or the computer-readable medium 922 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 922 may include a solid-state memory such as a memory card or other package that houses one or more non-volatile read-only memories. The computer-readable medium 922 also may be a random access memory or other volatile re-writable memory. Additionally, the computer-readable medium 922 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method of providing an advertisement to a user matched to a content type of a user requested content, comprising:
associating each advertisement in a plurality of advertisements with one or more content types, each content type describing a content of each advertisement;
receiving a request for one or more items of a content type from a user on a mobile device, wherein the mobile device is associated with a mobile carrier;
identifying the content type of the items;
determining an advertisement in the plurality of advertisements associated with the content type of the items; and
providing the advertisement to the user via the mobile device.

2. The method of claim 1 further comprising associating each advertisement in the plurality of advertisements with one or more mobile carriers.

3. The method of claim 2 wherein determining an advertisement in the plurality of advertisements associated with the content type of the items further comprises determining an advertisement in the plurality of advertisements associated with the content type of the items, and at least one of the mobile carrier associated with the mobile device of the user, and a location of the user.

4. The method of claim 2 wherein the requested items are associated with a search query.

5. The method of claim 4 further comprising determining an advertisement in the plurality of advertisements associated with the search query and the mobile carrier associated with the mobile device of the user if there are no advertisements associated with the content type of the items.

6. The method of claim 1 wherein providing the advertisement to the user further comprises causing the advertisement to be displayed on the mobile device of the user.

7. The method of claim 1 wherein at least one of the content types comprises at least one of a global content, a regional content, an operator content, and a user generated content.

8. The method of claim 1 wherein associating each advertisement in a plurality of advertisements with one or more content types further comprises associating each advertisement in a plurality of advertisements with one or more content types based on an algorithmic inference.

9. The method of claim 1 wherein associating each advertisement in a plurality of advertisements with one or more content types further comprises associating each advertisement in a plurality of advertisements with one or more content types, the associating performed by an advertiser associated with each advertisement.

10. The method of claim 1 further comprising providing the items and the advertisement to the user via the mobile device.

11. A method of providing an advertisement to a user matched to a search concept, comprising:
associating each search query in a plurality of search queries with the one or more search concepts, each search concept relating to an intent of each search query;
associating each advertisement in a plurality of advertisements with the one or more search concepts;
receiving a search query in the plurality of search queries from a user on a mobile device, wherein the mobile device is associated with a mobile carrier;
determining the search concept in the plurality of search concepts associated with the search query;
determining an advertisement in the plurality of advertisements associated with the search concept; and
providing the advertisement to the user via the mobile device.

12. The method of claim 11 wherein providing the advertisement to the user via the mobile device further comprises causing the advertisement to be displayed on the mobile device of the user.

13. The method of claim 11 further comprising associating each advertisement with one or more mobile carriers.

14. The method of claim 13 wherein determining an advertisement in the plurality of advertisements associated with the search concept further comprises determining an advertisement in the plurality of advertisement associated with the search concept and at least one of the mobile carrier associated with the mobile device of the user and a location of the user.

15. The method of claim 13 further comprising determining an advertisement in the plurality of advertisements related to the search query and the mobile carrier associated with the mobile device of the user if there are no advertisements associated with the search concept.

16. The method of claim 13 further comprising:
associating each search concept with a mobile carrier in a plurality of mobile carriers; and
determining an advertisement in the plurality of advertisements associated with the search concept and the mobile carrier associated with the mobile device of the user.

17. The method of claim 11 wherein at least one search concept comprises a search concept based on at least one of an address, a celebrity actor, a celebrity music, a celebrity newsmaker, a city, a landmark, a company, a local business, a country, a movie title, a product, a horoscope, a sports team, a sports player, and a sports league.

18. The method of claim 11 wherein associating each advertisement in a plurality of advertisements with the one or more search concepts further comprises associating each advertisement in a plurality of advertisements with the one or more search concepts, the associating performed by an advertiser associated with each advertisement.

19. The method of claim 11 wherein associating each advertisement in a plurality of advertisements with the one or more search concepts further comprises associating each advertisement in a plurality of advertisements with the one or more search concepts based on an algorithmic inference.

20. A system for providing an advertisement to a user matched to a content type of a user requested content, comprising:
a memory to store a plurality of advertisements and a request;
an interface operatively connected to the memory to communicate with a user on a mobile device, wherein the mobile device is associated with a mobile carrier; and
a processor operatively connected to the memory and the interface the processor for running instructions, wherein the processor associates each advertisement in the plurality of advertisements with the one or more content types, each content type describing a content of each advertisement, receives the request for one or more items of a content type from the user via the interface, identifies the content type of the items, determines an advertisement in the plurality of advertisements associated with the content type of the items, and provides the advertisement to the user via the interface.

21. The system of claim 20 wherein at least one content type comprises at least one of a global content, a regional content, an operator content, and a user generated content.

22. The method of claim 20 wherein the processor determines an advertisement in the plurality of advertisements associated with the content type of the items, and at least one of the mobile carrier and a location of the user.

23. The method of claim 20 wherein the one or more items are associated with a search query.

24. The system of claim 23 wherein the processor determines an advertisement in the plurality of advertisements related to the search query and the mobile carrier if there are no advertisements related to the content type.

25. The system of claim 20 wherein the processor provides the requested items and the advertisement to the user via the interface.
